(19) United States
(12) Patent Application Publication
(10) Pub. No.: US 2005/0212882 A1
(43) Pub. Date: Sep. 29, 2005

(54) Ink jet image forming apparatus and method

(75) Inventor: Mutsumi Naniwa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/086,369

(22) Filed: Mar. 23, 2005

(30) Foreign Application Priority Data
Mar. 23, 2004 (JP) 2004-085167

(51) Int. Cl. B41J 2/01

(52) U.S. Cl. 347/102; 347/105; 347/101

(57) ABSTRACT

The ink jet image forming apparatus has a forming device for forming an image on a recording medium, using ink containing particles including at least a colorant and a solvent, a fixing device for performing heat-fixing of the image formed by the forming device to thereby obtain a fixed image, a solvent removing device for removing the solvent in the ink forming the image before the heat-fixing by the fixing device, and a liquid coating device for coating the recording medium with a fixing assistant liquid for accelerating the heat-fixing of the image formed with the ink.

This application claims priority on Japanese patent application No. 2004-85167, the entire contents of which are hereby incorporated by reference. In addition, the entire contents of literatures cited in this specification are incorporated by reference.

### BACKGROUND OF THE INVENTION

The present invention relates to an ink jet image forming apparatus and method, and more particularly to an ink jet image forming apparatus such as an ink jet copier, printer or printing machine in which an image is recorded on a recording medium by an ink jet system and the recorded image is heated for fixation to thereby perform image formation, and an ink jet image forming method used in the ink jet image forming apparatus.

Recently, owing to the remarkable advancement of the ink jet technique, it has been possible to record high-quality images at a high speed, and various images (hard copies) whose quality is comparable to that of silver halide photographs have been developed. Furthermore, the use in the offset printing for preparing a color proof for printed material or the on-demand color printing has been possible. Under such circumstances, there is an increasing demand for enhancing the precision of the color proof and the quality of printed material in the on-demand color printing by providing desired glossiness to an image.

However, according to the conventional ink jet system, the control of the glossiness of an image generally depends upon a dedicated recording medium. More specifically, a plurality of kinds of recording media which allow a predetermined glossiness to be expressed by ink jet recording are commercially available, and these recording media are chosen in accordance with the purpose.

For example, JP 2003-80692 A discloses an ink jet printer capable of recording an image having glossiness comparable to a photograph quality. In this printer, an image is written, and then, fixed within a short period of time (e.g., within 3 minutes). Furthermore, a recording medium having a hot-melt resin layer is used, and the hot-melt resin layer is molten during fixing.

Furthermore, JP 2003-103898 A discloses an ink jet recording method using pigment ink. According to this method, in order to obtain an ink jet pigment image having glossiness comparable to that of a silver halide photograph, the C-value of a pigment image is adjusted to be 60 or more. Specific examples thereof include: a method in which an image is printed on a recording medium with ink pigments, then heat or a pressure is applied to the image and a solvent and a plasticizer are added to further heat the image; a method in which an image is heated after a thermoplastic resin component is supplied to the image; and a method in which a recording medium having a surface layer containing a thermoplastic resin is used and the thermoplastic resin is molten during the fixation of a pigment image by heating to thereby form a coating film.

Furthermore, JP 2003-118090 A discloses a structure in order to solve problems described below. In a fixing member such as a fixing belt or a fixing roller used in an ink jet recording apparatus, a film is likely to peel off from the fixing member. In addition, there are such problems that sufficient glossiness cannot be obtained and the surface of an image is roughened due to the offset with respect to the fixing member, with the result that an image with glossiness cannot be obtained. In the structure disclosed in JP 2003-118090 A, the surface layer of the fixing belt is coated with curable silicone by dipping, and thereafter, the resultant surface layer is cured by heating so as to obtain a peeling force of 30 g/5 cm or more. This makes the glossiness of the obtained fixed image satisfactory, and can prevent the film peeling and offset of the fixing member during heat-fixing.

JP 2003-80692 A and JP 2003-103898 A describe that an ink jet image with glossiness comparable to that of a silver halide photograph can be obtained as their effect. However, the ink jet recording described in these publications aims to obtain an image with very high glossiness comparable to that of a silver halide photograph, and an image recorded on a recording medium by ink jet recording is made to have glossiness sufficiently higher than that to be generally expressed, i.e., glossiness corresponding to the recording medium. To this end, a method in which a dedicated recording medium having a surface layer made of a thermoplastic resin is used and the expression of the glossiness mainly depends on the dedicated recording medium; a method in which the time required from recording to fixation is sufficiently shortened; and a method in which a solvent and a plasticizer are applied are adopted.

Furthermore, JP 2003-118090 A also describes that an image with satisfactory glossiness can be obtained as its effect. The fixing member described in JP 2003-118090 A is configured so as not to decrease the glossiness to be expressed by an image recorded on a recording medium by ink jet recording, i.e., the glossiness corresponding to the recording medium.

Thus, in any of the above-mentioned ink jet recording apparatuses and the like, the glossiness of an image cannot be controlled freely irrespective of the kind (property) of a recording medium, for example, without using a dedicated recording medium. In particular, an image that expresses lower glossiness than that corresponding to the recording medium cannot be obtained, and the demand for providing an image with desired glossiness cannot be satisfied.

### SUMMARY OF THE INVENTION

An object of the present invention is to solve the above-mentioned problems of the conventional techniques, and to provide an ink jet image forming apparatus capable of controlling glossiness irrespective of the kind of a recording medium, for example, without using a dedicated recording medium.

Another object of the present invention is to provide an ink jet image forming method used in the ink jet image forming apparatus.

In order to achieve the above-mentioned object, the present invention provides an ink jet image forming apparatus, comprising: forming means for forming an image on a recording medium, using ink containing particles including at least a colorant and a solvent; fixing means for performing heat-fixing of the image formed by the forming means to thereby obtain a fixed image; solvent removing means for removing the solvent in the ink forming the image before the heat-fixing by the fixing means; and liquid coating means for coating the recording medium with a fixing assistant liquid for accelerating the heat-fixing of the image formed with the ink.

Preferably, the ink jet image forming apparatus further comprises control means for controlling glossiness of the fixed image by controlling whether or not the solvent in the ink forming the image is removed by the solvent removing means and whether or not the fixing assistant liquid is applied by the liquid coating means.

Preferably, the control means controls the glossiness of the fixed image by controlling whether or not the solvent in the ink forming the image is removed by the solvent removing means and whether or not the fixing assistant liquid is applied by the liquid coating means, in accordance with one or both of the glossiness to be expressed by the fixed image and a kind of the recording medium.

Preferably, when performing one or both of removal of the solvent by the solvent removing means and application of the fixing assistant liquid by the liquid coating means, the control means adjusts one or both of an amount of the solvent removed from the ink forming the image by the solvent removing means and an amount of the fixing assistant liquid applied by the liquid coating means, in accordance with one or both of the glossiness to be expressed by the fixed image and a kind of the recording medium.

Preferably, the fixing means fixes the image by bringing a heating member into contact with the recording medium.

Also, the present invention provides an ink jet image forming method, comprising: forming an image on a recording medium using ink containing particles including at least a colorant and a solvent; determining whether or not the solvent in the ink forming the image is removed and whether or not the recording medium is coated with a fixing assistant liquid for accelerating heat-fixing of the image formed with the ink so that glossiness of a fixed image is controlled; and heat-fixing the image based on a determination made on removal and application to obtain the fixed image.

Preferably, whether or not the solvent in the ink forming the image is removed and whether or not the recording medium is coated with the fixing assistant liquid for accelerating the heat-fixing of the image formed with the ink are determined in accordance with one or both of the glossiness to be expressed by the fixed image and a kind of the recording medium.

Preferably, when performing one or both of removal of the solvent in the ink forming the image and application of the fixing assistant liquid to the recording medium, one or both of an amount of the solvent removed from the ink forming the image and an amount of the fixing assistant liquid applied are adjusted, in accordance with one or both of the glossiness to be expressed by the fixed image and a kind of the recording medium.

An ink jet image forming apparatus of the present invention includes means for coating an image area with a fixing assistant liquid that enhances the glossiness of an image, and means for removing a solvent in ink on a recording medium so as to suppress the glossiness of the image. Therefore, by controlling these means to adjust the coating amount of the fixing assistant liquid and the removal amount of the ink solvent, desired glossiness can be expressed on a recorded image. Thus, the glossiness of an image can be controlled freely without choosing a specific recording medium, for example without using a dedicated recording medium.

Furthermore, according to the ink jet image forming apparatus and method of the present invention, the removal amount of the ink solvent and the coating amount of the fixing assistant liquid are adjusted in accordance with one or both of the kind of a recording medium and desired glossiness in an image to be recorded on the recording medium, whereby various needs for the kind of a recording medium and the glossiness of an image can be satisfied.

### BRIEF DESCRIPTION OF THE DRAWINGS

In the accompanying drawings:

FIG. 1 is a schematic cross-sectional view showing a schematic configuration of an ink jet image forming apparatus according to an embodiment of the present invention in which an ink jet image forming method of the present invention is implemented;

FIGS. 2A to 2C are schematic cross-sectional views each showing a schematic configuration of the ink jet image forming apparatus according to another embodiment of the present invention;

FIGS. 3A to 3C are schematic cross-sectional views each showing a schematic configuration of the ink jet image forming apparatus according to still another embodiment of the present invention;

FIG. 4 is a conceptual view illustrating an image obtained by the ink jet image forming apparatus of the present invention;

FIGS. 5A and 5B are schematic cross-sectional views each showing a schematic configuration of the ink jet image forming apparatus according to yet another embodiment of the present invention;

FIG. 6 is a conceptual view showing a schematic configuration of an embodiment in which the ink jet image forming apparatus shown in FIG. 4 is applied to an electrostatic ink jet image forming apparatus;

FIG. 7A is a schematic cross-sectional view showing a part of an ejection head; and

FIG. 7B is a schematic cross-sectional view taken along the line VII-VII of FIG. 7A.

### DETAILED DESCRIPTION OF THE PREFERRED EMBODIMENTS

An ink jet image forming apparatus and method according to the present invention will be described below in detail by way of preferred embodiments with reference to the accompanying drawings.

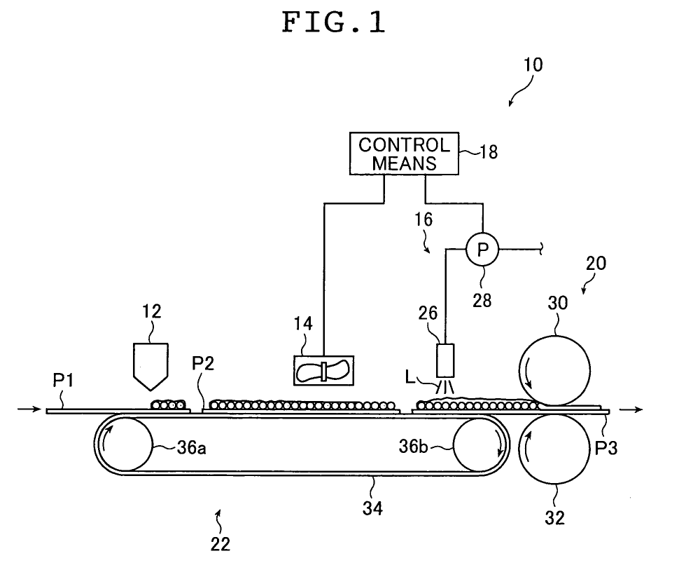

FIG. 1 is a schematic cross-sectional view showing a schematic configuration of an ink jet image forming apparatus according to an embodiment of the present invention in which an ink jet image forming method of the present invention is implemented. An ink jet image forming apparatus 10 (hereinafter, simply referred to as “image forming apparatus 10”) shown in FIG. 1 includes forming means 12 for forming (drawing) an ink image on a recording medium P (P1, P2, P3) by an ink jet system, solvent removing means 14 for removing an ink solvent on the recording medium P, liquid coating means 16 for coating an ink image on the recording medium P with a liquid L that is a fixing assistant liquid for enhancing glossiness, control means 18 for controlling the glossiness of a fixed image by controlling the solvent removing means 14 and the liquid coating means 16, fixing means 20 for fixing the ink image, and transporting means 22 for transporting the recording medium P from the forming means 12 to the fixing means 20.

As the recording medium P, paper such as plain paper, woodfree paper, ultra lightweight coat paper, coated paper, art paper, and cast-coated paper, or a film for printing can be used without any particular limitation.

The forming means 12 uses ink containing particles including a colorant (color particles) and a solvent, and ejects ink by an ink jet system, thereby forming an ink image on the recording medium P. As the forming means 12, various kinds of ink jet systems such as an electrostatic ink jet system, a thermal ink jet system, and a piezoelectric ink jet system can be used.

An example of the ink used by the forming means 12 includes ink in which color particles with a diameter of about 0.1 to 5 μm are dispersed in an aqueous solvent or a non-aqueous solvent. Furthermore, the ink may contain dispersed resin particles and the like for enhancing the fixing property of a printed image appropriately together with the color particles.

The solvent removing means 14 removes the ink solvent in the ink forming an ink image on the recording medium P before fixing the image in the fixing means 20. The solvent removing means 14 evaporates the ink solvent almost uniformly over the entire area in a width direction of the recording medium P (direction orthogonal to a transport direction of the recording medium P), and is placed so as to be opposed to a transporting belt 34. The transporting means 22 passes the recording medium P beneath the solvent removing means 14, whereby the ink solvent on the recording medium P is removed.

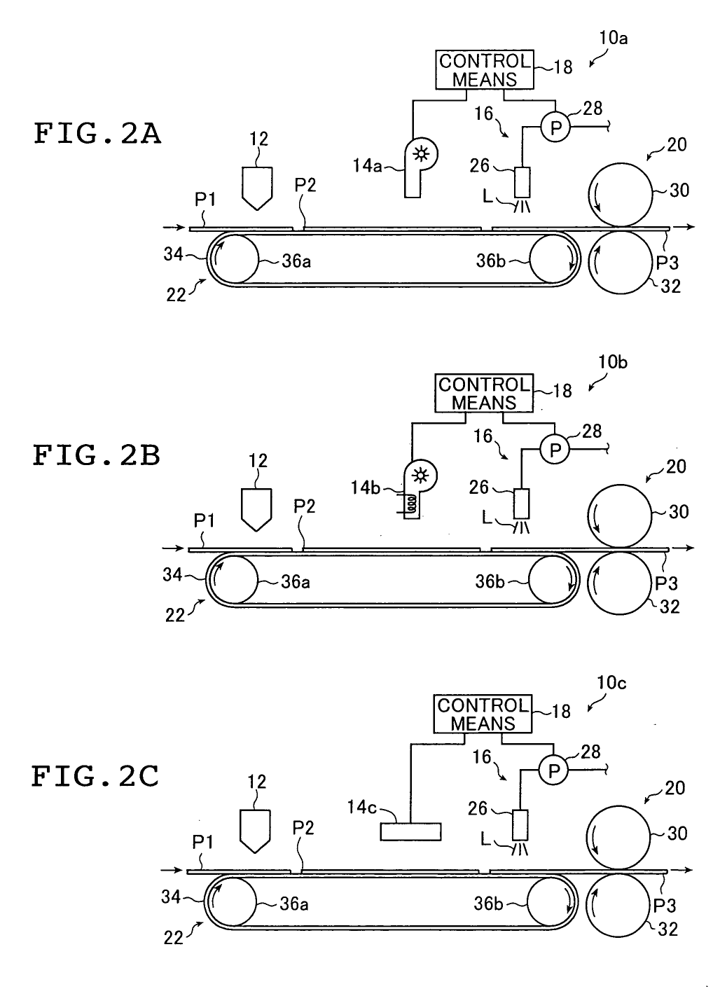

As the solvent removing means 14, not only a fan for blowing air at room temperature toward the recording medium P as shown in FIG. 1, but also a blower 14a for blowing air at room temperature as shown in an image forming apparatus 10a of FIG. 2A or a blower 14b with heater for blowing hot air as shown in an image forming apparatus 10b of FIG. 2B may be used. The image forming apparatus 10b using the blower 14b with heater is preferable since the time necessary for removing a solvent can be shortened substantially. Furthermore, as shown in FIG. 2C as an image forming apparatus 10c, it is also possible to use a heater 14c to perform non-contact heating, without relying on blowing function. In the case of using the blower 14b with heater and the heater 14c, the hot air temperature and the heater temperature are set at temperatures at which the color particles forming an ink image are not molten. Furthermore, in addition to the above, an aspirator and the like for aspirating air on the surface of the recording medium P may be used.

It is preferable that the solvent removing means 14 be configured so that the blown air and heat uniformly act on predetermined areas of the surface of the transporting belt 34 (surface of the recording medium P), and it is also preferable that more than one solvent removing means 14 be arranged in the transport direction or the width direction of the recording medium P. Furthermore, it is also preferable to block the area of the solvent removing means 14 so that the air and heat supplied from the solvent removing means 14 do not adversely affect other parts (e.g., dry the ejection portions of an ink jet head 108).

The liquid coating means 16 coats the ink image formed on the recording medium P by the forming means 12 with the liquid L. The liquid coating means 16 includes a nozzle 26 and a pump 28, and the pump 28 supplies the liquid L in a tank (not shown) containing the liquid L to the nozzle 26. The nozzle 26 is arranged over the entire width of the recording medium P, and the liquid L pumped out from the tank by the pump 28 is sprayed from the nozzle 26, and applied almost uniformly in the width direction of the recording medium P. The recording medium P is coated with the liquid L while passing beneath the liquid coating means 16 by the transporting means 22.

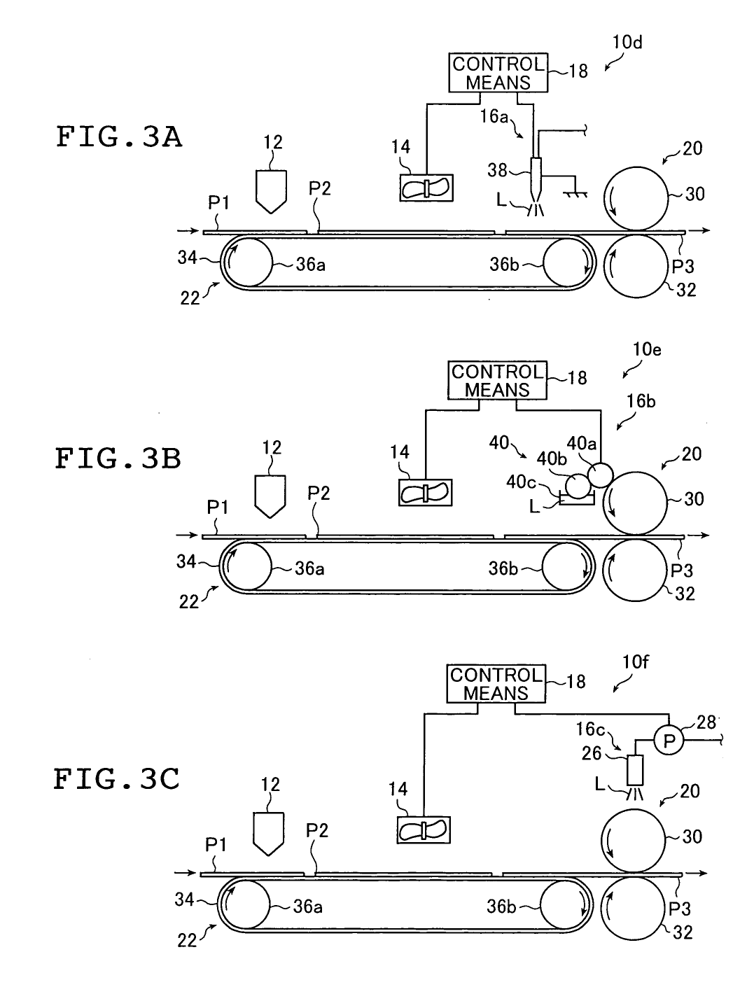

As the liquid coating means 16, any means may be used as long as it can coat an ink image formed on the recording medium P with the liquid L almost uniformly, in addition to the means for spraying the liquid L from the nozzle 26 as shown in FIG. 1. For example, as shown in FIG. 3A as an image forming apparatus 10d, an ink jet head 38 may be provided as the liquid coating means 16a in place of the nozzle 26 and the pump 28, and the liquid L may be ejected from the ink jet head 38 to uniformly coat an ink image formed on the recording medium P with the liquid L. Various systems such as an electrostatic system, a thermal system, and a piezoelectric system may be used in the ink jet head 38 functioning as the liquid coating means 16a. Thus, the liquid L can be selectively applied only to an area of an ink image formed on the recording medium P by using the ink jet head 38 as the liquid coating means 16a, so that there is an effect of reducing the consumption amount of the liquid L. Furthermore, by controlling the ink jet head 38, the liquid L can be adjusted to a uniform and constant coating amount, compared with the case of using the nozzle 26 shown in FIG. 1.

Furthermore, a configuration of an image forming apparatus 10e shown in FIG. 3B is also possible. To be more specific, a liquid supply device 40 is provided, which includes a liquid supply roller 40a for supplying the liquid L to a heating roller 30 of the fixing means 20, a pumping roller 40b for pumping up the liquid L to supply to the liquid supply roller 40a, and a liquid tank 40c containing the liquid L to be pumped up by the pumping roller 40b. The liquid L is supplied from the liquid supply device 40 to the heating roller 30. Upon application of the liquid L to an ink image formed on the recording medium P by the heating roller 30, the ink image to which the liquid is applied is fixed. The liquid coating means 16b may be composed of the liquid supply device 40 and the heating roller 40a as in the image forming apparatus 10e.

Furthermore, a configuration of an image forming apparatus 10f shown in FIG. 3C is also possible. To be more specific, the liquid L is supplied to the heating roller 30 of the fixing means 20, using the nozzle 26 and the pump 28 of the image forming apparatus 10 shown in FIG. 1, in place of the liquid supply device 40 of the image forming apparatus 10e shown in FIG. 3B. The liquid L is supplied from the nozzle 26 to the heating roller 30. Upon application of the liquid L to an ink image formed on the recording medium P by the heating roller 30, the ink image to which the liquid is applied is fixed. The liquid coating means 16c may be composed of the nozzle 26, the pump 28, and the heating roller 30 as in the image forming apparatus 10f.

As the liquid L applied to an ink image on the recording medium P by the liquid coating means 16, any liquid may be used as long as it makes color particles in the ink forming the ink image easily melt or soften, enhances the meltability during heat-fixing, and accelerates heat-fixing of an image. It is preferable to use the ink solvent used in the forming means 12 as the liquid L in terms of the simple configuration of the image forming apparatus 10 and maintenance. Furthermore, it is also preferable to use, as the liquid L, a liquid similar to the ink solvent used in the forming means 12, i.e., the liquid containing at least one component of the ink solvent.

When a liquid that dissolves a resin component of the color particles, such as a solvent used in the conventional solvent fixing, is used as the liquid L, it is advantageous for uniform film formation; however, such a liquid cannot be used since offset of an ink image is likely to occur on the heating roller 30 on a side contacting an image surface of the recording medium P in the fixing means 20. Therefore, the liquid that can be used in the present invention is clearly distinguished from the solvent used for the conventionally known solvent fixing.

Thus, the liquid that can be used in the present invention preferably has a resin solubility of 20% or less, more preferably 15% or less, and most preferably 10% or less at a fixing temperature of, for example, 90° C.

As the liquid for accelerating such heat-fixing, any solvent may be used as long as it has the above-mentioned characteristics. Examples of the solvent include a hydrocarbon solvent, halogen-substituted hydrocarbon solvent, and silicone solvent.

Examples of the hydrocarbon solvent include pentane, isoheptane, octane, isooctane, decane, isodecane, decalin, nonane, dodecane, isododecane, cyclohexane, cyclooctane, cyclodecane, benzene, toluene, xylene, mesitylene, Isopar E, Isopar G, Isopar H, Isopar L (Isoper (trade name) available from Exxon Corporation), Shellsol 70, Shellsol 71 (Shellsol (trade name) available from Shell Oil Company), AMSCO OMS, and AMSCO 460 solvent (AMSCO (trade name) available from Spirits Co., Ltd.).

As the halogen-substituted hydrocarbon solvent, there is a fluorocarbon solvent. Examples of the fluorocarbon solvent include perfluoroalkanes represented by CₙF₂ₙ₊₂ such as C₇F₁₆ and C₈F₁₈ (“Fluorinert PF5080”, and “Fluorinert PF5070” (trade name) produced by Sumitomo 3M Ltd., etc.); fluorine inactive liquid (“Fluorinert FC series” (trade name) produced by Sumitomo 3M Ltd., etc.); fluorocarbons (“Krytox GPL Series” (trade name) produced by Du Pont Kabushiki Kaisha); Chlorofluorocarbons (“HCFC-141b” (trade name) produced by Daikin Industries, Ltd., etc.); and iodinated fluorocarbons such as [F(CF₂)₄CH₂CH₂I] and [F(CF₂)₆I] (“I-1420”, “I-1600” (trade name) produced by Daikin Fine Chemical Laboratory, etc.).

Examples of the silicone liquid and silicone oil used as the silicone solvent include dialkylpolysiloxanes (e.g., hexamethyldisiloxane, tetramethyldisiloxane, octamethyltrisiloxane, hexamethyltrisiloxane, heptamethyltrisiloxane, decamethyltetrasiloxane, (trifluoropropyl)heptamethyltrisiloxane, and diethyltetramethyldisiloxane); cyclic dialkylpolysiloxanes (e.g., hexamethylcyclotrisiloxane, octamethylcyclotetrasiloxane, tetramethylcyclotetrasiloxane, and tetra(trifluoropropyl)tetramethylcyclotetrasiloxane); and methylphenyl silicone oil (e.g., KF56, and KF58 (trade name) produced by Shi-Etsu Chemical Co., Ltd.).

Examples of the solvent also include alcohols (e.g., ethyl alcohol, propyl alcohol, butyl alcohol, ethylene glycol monomethyl ether, and fluorinated alcohol); ketones (e.g., methyl ethyl ketone, acetophenone, and cyclohexanone); carboxylic esters (e.g., methyl acetate, ethyl acetate, propyl acetate, butyl acetate, methyl propionate, ethyl propionate, and ethylene glycol monomethyl ether acetate); ethers (e.g., dipropyl ether, ethylene glycol dimethyl ether, tetrahydrofuran, and dioxane); and halogenated hydrocarbons (e.g., chloroform, dichloroethane, and methylchloroform).

In the present invention, these solvents may be used alone or in combination.

The control means 18 controls the solvent removing means 14 and the liquid coating means 16 so as to allow the solvent removing means 14 to remove an ink solvent from an ink image formed on the recording medium P or allow the liquid coating means 16 to coat the ink image with the liquid L, thereby controlling the glossiness to be expressed on an image after being fixed by the fixing means 20. The method for controlling image glossiness with the control means 18 will be described later in detail.

The fixing means 20 brings the fixing roller that is a heating member into contact with the recording medium P, thereby performing heat-fixing, and has a heating roller 30 and a pressing roller 32. The recording medium P is held and transported by the heating roller 30 and the pressing roller 32, whereby an ink image formed on the recording medium P by the forming means 12 is fixed.

The heating roller 30 contains a heating source such as a heater or a halogen lamp, and comes into contact with an image recording surface of the recording medium P to heat the recording medium P. Furthermore, the pressing roller 32 presses the recording medium P against the heating roller 30 with a predetermined pressing force that is uniform in a roller axis direction. Owning to the heating by the heating roller 30 and the pressing force by the pressing roller 32, the ink solvent on the recording medium P is evaporated, and the color particles are softened to be molten, whereby the colorant is fixed to the recording medium P.

It is preferable that the surfaces of the heating roller 30 and the pressing roller 32 have excellent releasability, and be made of, for example, silicone rubber, fluorine rubber, or the like, and coated with a release agent such as oil.

The heating roller 30 and the pressing roller 32 may be both heating rollers. Furthermore, the surface temperature of the heating roller 30 and the pressing force of the pressing roller 32 to the recording medium P (nip force between the heating roller 30 and the pressing roller 32) only need to be appropriately set so as to ensure a desired fixing property. It is also preferable that the surface layers of the heating roller 30 and the pressing roller 32 be made of an elastic material, and the recording medium P and the heating roller 30 are brought into surface contact with each other with the pressing force by the pressing roller 32, whereby sufficient time for heat-fixing is ensured.

Furthermore, a heating belt and a pressing belt may be used in place of the heating roller 30 and the pressing roller 32.

As the fixing means 20, non-contact heat-fixing with a heater or the like is available in addition to the contact heat-fixing. In terms of the heat efficiency and the stability of a surface property of a fixed image, it is preferable to perform the contact heat-fixing in the above configuration.

The transporting means 22 holds the recording medium P and transports it from the forming means 12 to an entrance of the fixing means 20 at a predetermined speed. The transporting means 22 has a transporting belt 34 that is an endless belt, and belt rollers 36a, 36b for stretching and rotating the transporting belt 34 therearound. At least one of the belt rollers 36a, 36b is connected to a drive source, and is rotated in a predetermined direction (clockwise in an illustrated example) so that the transporting belt 34 is rotated therearound.

At a position corresponding to the forming means 12, the transporting means 22 functions as main-scanning transporting means in image formation, and transports the recording medium P at a predetermined speed required for forming an image. Furthermore, the transporting means 22 transports the recording medium P at a constant speed in the solvent removing means 14 and the liquid coating means 16, respectively. Because of this, the removal of the ink solvent by the solvent removing means 14 and the coating of the ink solvent by the liquid coating means 16 are performed uniformly from a leading edge to a trailing edge in the transport direction of the recording medium P, whereby the amount of the ink solvent can be made substantially uniform over the entire surface of an ink image formed on the recording medium P.

In FIG. 1, the transporting means 22 as a single entity is used for the forming means 12, the solvent removing means 14 and the liquid coating means 16. However, in the case where it is necessary to change the transport speed in each step, the transporting means for transporting the recording medium P at a predetermined transport speed may be provided separately for each step. Furthermore, the transporting means 22 is not limited to belt transport in the illustrated example, and any known transporting means can be used. However, in order to ensure the precision of image recording in the forming means 12, and the consistent image quality in the solvent removing means 14 and the liquid coating means 16, it is important to hold the recording means P in a non-image recording surface of the recording medium P, or a non-image recording area of the image recording surface without fail. Preferable examples include a method in which the recording medium P is electrostatically attracted to the surface of the transporting belt 34, and a method in which the recording medium P is attracted to the transporting belt 34 by producing a vacuum on the transporting belt 34 side.

Next, the function of the image forming apparatus 10 will be described, and the control of glossiness by the control means 18 will be described in detail.

The recording medium P is transported at a predetermined speed by the transporting means 22, and an ink image is formed by the forming means 12 (recording medium P1 in FIG. 1). Then, an ink solvent in the ink image is removed by the solvent removing means 14 (recording medium P2 in FIG. 1), the ink image is coated with the liquid L by the liquid coating means 16 (recording medium P3 in FIG. 1), or the ink image is transported to the fixing means 20 without removal of an ink solvent or coating with the liquid L. Whether or not the ink solvent is removed by the solvent removing means 14 and whether or not the liquid L is applied by the liquid coating means 16 are controlled by the control means 18.

As described above, the ink solvent and the liquid L have functions of acting on a resin component and dispersed resin particles in the color particles in ink, facilitating the melting of the color particles and the like, and accelerating heat-fixing. Therefore, the amount of the ink solvent in an ink image and the presence/absence of the liquid L determine the glossiness of a fixed image.

More specifically, for example, when the amount of the ink solvent in an ink image is large or the ink image is coated with the liquid L, a colorant, color particles, and dispersed resin particles are swollen, plasticized, and the like, whereby they are likely to melt and heat-fixing is accelerated. The shape of the color particles and the like is crushed or largely deformed as if it was crushed due to heat-fixing by the fixing means 22. Consequently, the surface of the fixed image has less unevenness, i.e., has smaller surface roughness, compared with the case where the ink solvent is not removed, the liquid L is not applied, and the ink solvent is used in a usual amount. Thus, the glossiness of an image is enhanced.

In contrast, when the amount of the ink solvent in an ink image is small, and the liquid L is not applied, the color particles and dispersed resin particles are unlikely to melt, so that heat-fixing is not accelerated. The shape of the color particles and the like is hardly deformed even with heat-fixing by the fixing means 20, and the original particle shape is mostly kept after heat-fixing. Consequently, the surface of the fixed image is made uneven, i.e., has a larger surface roughness, compared with the case where the ink solvent is not removed, the liquid L is not applied, and the ink solvent is used in a usual amount. Thus, the glossiness of an image is suppressed.

Thus, when it is desired to enhance the glossiness of a recorded image, the liquid L is applied in a predetermined amount by the liquid coating means 16, and when it is desired to decrease the glossiness of a recorded image, the ink solvent is removed in a predetermined amount by the solvent removing means 14, whereby the glossiness of a recorded image to be obtained after fixing can be controlled.

In the case where the recording medium P of one kind is used, and it is desired to change the glossiness of fixed images, the control means 18 controls the solvent removing means 14 and the liquid coating means 16 so as to obtain desired glossiness. Furthermore, in the case where the recording media P of different kinds are used, the control condition of glossiness, i.e., the amount of the ink solvent and the amount of the liquid L in an ink image when the same glossiness is obtained, are varied depending upon the kind of the recording medium P. Therefore, the solvent removing means 14 and the liquid coating means 16 are controlled in accordance with the kind of the recording medium P and the glossiness desired to be expressed.

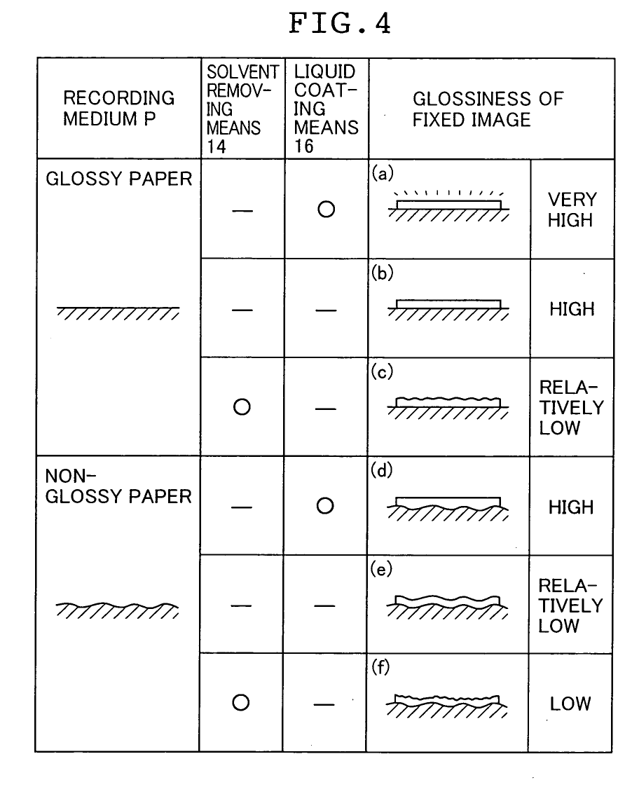

A detailed description will be made with reference to FIG. 4. FIG. 4 is a conceptual view illustrating an image obtained when the solvent removing means 14 and the liquid coating means 16 are controlled by the control means 18. An upper part of FIG. 4 shows the case where glossy paper with a smaller surface roughness and higher glossiness (e.g., art paper) is used as the recording medium P, and a lower part shows the case where non-glossy paper (e.g., woodfree paper) with a larger surface roughness and a lower glossiness) is used as the recording medium P.

As shown in the upper part of FIG. 4, in the case where an ink image formed by the forming means 12 is fixed on the glossy paper by the fixing means 20 under a normal condition, i.e., without operating the solvent removing means 14 and the liquid coating means 16, a fixed image (recorded image) obtained after fixing is an image with high glossiness corresponding to the surface property of the glossy paper, as shown in a column (b) of FIG. 4.

In the case where glossy paper is used, and the liquid L is applied to an ink image formed by the forming means 12 by the liquid coating means 16, the glossiness of a fixed image increases greatly as shown in a column (a) of FIG. 4.

In contrast, in the case where the ink solvent is removed from an ink image formed by the forming means 12 by the solvent removing means 14, and the amount of the ink solvent is decreased, the glossiness of a fixed image decreases slightly, as shown in a column (c) of FIG. 4.

Thus, even in the case where the same glossy paper is used as the recording medium P, the control means 18 controls the solvent removing means 14 and the liquid coating means 16 to remove the ink solvent in an ink image formed on the recording medium P or apply the liquid L, whereby the glossiness of a fixed image can be controlled. Furthermore, at this time, by adjusting the amount of the ink solvent removed by the solvent removing means 14 and the amount of the liquid L applied by the liquid coating means 16, the glossiness of a fixed image can be controlled more finely.

Furthermore, even in the case of recording an image on non-glossy paper, the glossiness of a fixed image can be controlled in the same way as in the above-mentioned glossy paper. For example, in the case where an ink image formed by the forming means 12 is fixed onto non-glossy paper by the fixing means 20 under a normal condition, i.e., without operating the solvent removing means 14 and the liquid coating means 16, a fixed image (recorded image) obtained after fixing has a relatively low glossiness corresponding to the surface property of the non-glossy paper as shown in a column (e) of FIG. 4.

In contrast, in the case where the liquid L is applied to an ink image on the recording medium P by the liquid coating means 16, the glossiness of a fixed image increases as shown in a column (d) of FIG. 4. In the case where the ink solvent is removed from the ink image on the recording medium P by the solvent removing means 14, the glossiness of a fixed image decreases as shown in a column (f) of FIG. 4. Thus, even in the case where the non-glossy paper of one kind is used, the glossiness of fixed image can be controlled by allowing the control means 18 to control the solvent removing means 14 and the liquid coating means 16.

Furthermore, as is understood from the comparison between the case of the glossy paper shown in the upper part in FIG. 4 and the case of the non-glossy paper shown in the lower part in FIG. 4, an image having high glossiness comparable to that of an image recorded under a normal condition with the glossy paper can also be obtained by controlling the glossiness at a high level on the non-glossy paper, as shown in the column (d). Furthermore, by controlling the glossiness at a low level on the glossy paper, an image having a slightly low glossiness comparable to that of an image recorded under a normal condition with the non-glossy paper can also be obtained. More specifically, according to the image forming apparatus 10, an image having desired glossiness can be obtained irrespective of the kind of the recording medium P.

Thus, the recording medium P from which the ink solvent has been removed by the solvent removing means 14 or to which the liquid L has been applied by the liquid coating means 16 is transported to the fixing means 20. Then, the recording medium P is held and transported while being heated by the fixing means 20, whereby an ink image is fixed on the recording medium P, and a recorded image having desired glossiness is obtained.

In the image forming apparatus 10, the control means 18 performs on one recording medium P either one of the removal of the ink solvent by the solvent removing means 14 and the coating of the liquid L by the liquid coating means 16, thereby controlling the glossiness of an image to be recorded on the recording medium P. However, the present invention is not limited thereto. Both the removal of the ink solvent and the coating of the liquid L may be performed on one recording medium P. For example, in this embodiment, the solvent removing means 14 is placed on an upstream side of the liquid coating means 16 in the transport direction of the recording medium P. Therefore, after the ink solvent in an ink image of the recording medium P is removed by the solvent removing means 14, the liquid L can be applied to the ink image by the liquid coating means 16. Therefore, in the case where there are variations in the amount of the ink solvent in forming an ink image by the forming means 12, and in the case where the amount of the ink solvent is not uniform on a sheet of the recording medium P after an ink image is formed, the ink solvent on the recording medium P is removed almost completely by the solvent removing means 14, and thereafter, the liquid L is applied uniformly by the liquid coating means 16, whereby a fixed image of consistent quality can be obtained over the entire ink image.

Next, another embodiment of the present invention will be described.

In the embodiment in FIG. 1, the liquid coating means 16 is placed on a downstream side of the solvent removing means 14 in the transport direction of the recording medium P, thereby allowing the solvent removing means 14 to remove the ink solvent, and thereafter the liquid coating means 16 to apply the liquid L, for example. However, in the image forming apparatus of the present invention, the arrangement of the solvent removing means 14 and the liquid coating means 16 may be different from that of the embodiment shown in FIG. 1. As long as the solvent removing means 14 is placed between the forming means 12 and the fixing means 20, the positional relationship between the solvent removing means 14 and the liquid coating means 16 may be arbitrarily determined. Furthermore, the solvent coating means 16 may be placed on an upstream side of the forming means 12.

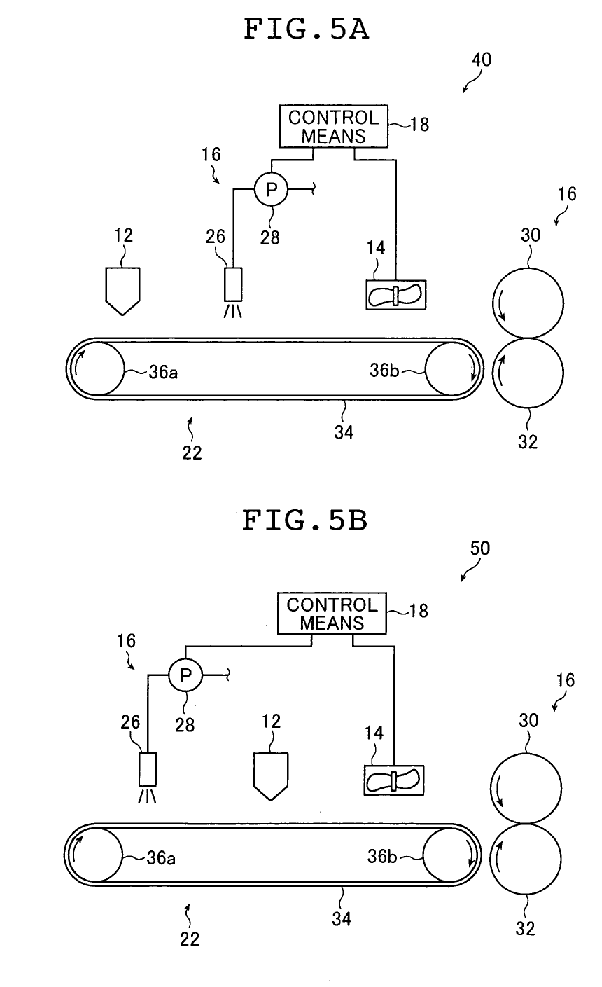

For example, as shown in FIG. 5A, the solvent removing means 14 may be placed on a downstream side (right side in FIG. 5A) of the liquid coating means 16 in the transport direction of the recording medium P. In this case, the fixing means 20 is placed immediately after the solvent removing means 14. Therefore, immediately after the ink solvent is removed by the solvent removing means 14, an ink image is fixed by the fixing means 20, whereby an ink image is prevented from being dried too much by natural air drying after the removal of the ink solvent, and the decrease in a fixing property in the fixing means 20 can be prevented. Furthermore, the following is also possible: the liquid L is applied by the liquid coating means 16, and thereafter, the liquid L is removed by the solvent removing means 14. In this case, the amount of the liquid L applied by the liquid coating means 16 can also be finely adjusted.

Furthermore, as shown in FIG. 5B, the following form may be adopted: the liquid coating means 16 is placed on an upstream side of the forming means 12, and before an ink image is formed by the forming means 12, the liquid L is applied to an ink image forming region of the recording medium P.

Next, an embodiment will be described in which the ink jet image forming apparatus of the present invention in which the ink jet image forming method of the present invention is implemented is applied to an electrostatic ink jet image forming method and apparatus. The electrostatic ink jet image forming apparatus that forms an ink image using an electrostatic ink jet head is capable of recording a high-resolution image. Therefore, the glossiness is controlled by the ink jet image forming apparatus and method of the present invention, so an image of higher quality can be obtained. This is a particularly preferable mode since various demanding needs in printing industry can be satisfied.

In the following, an example in which color particles in ink are positively charged will be described. Contrary to this, the color particles in ink that are negatively charged may be used. In this case, the polarity of each component involved in recording may be reversed with respect to the following example.

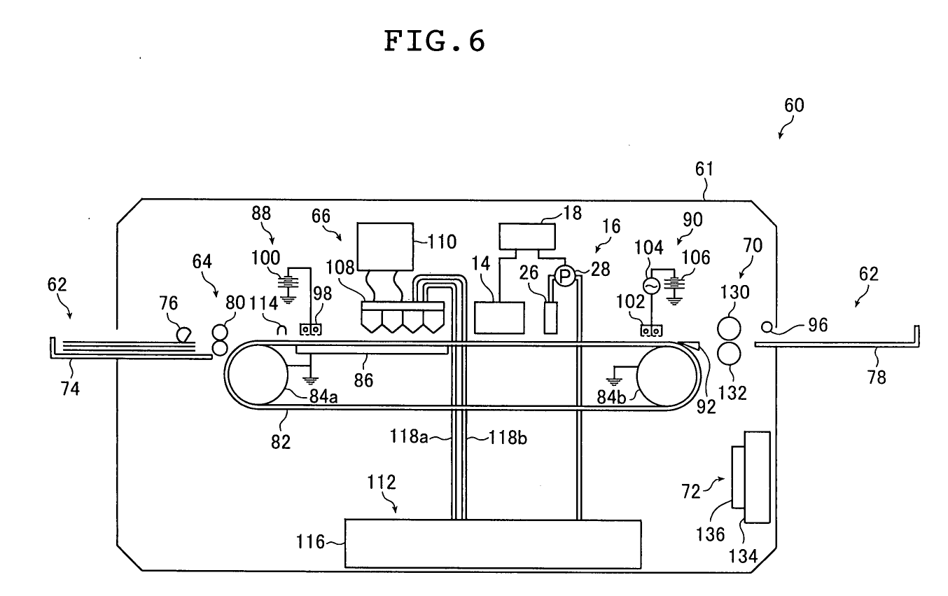

FIG. 6 is a conceptual diagram showing a schematic configuration of one embodiment of the electrostatic ink jet image forming apparatus according to the present invention. An image forming apparatus 60 shown in FIG. 6 controls the ejection of ink containing charged color particles (charged fine particles) by an electrostatic force, performs 4-color printing on the recording medium P to record a full-color image thereon, and thereafter, fixes the recorded image by contact-heating with a heating roller. The image forming apparatus 60 includes holding means 62 of the recording medium P, transporting means 64, recording means 66, solvent removing means 14, liquid coating means 16, control means 18 of the solvent removing means 14 and the liquid coating means 16, fixing means 70, and solvent collecting means 72, and these components are contained in a housing 61.

In the image forming apparatus 60 shown in FIG. 6, the solvent removing means 14, the liquid coating means 16, and the control means 18 are similar to the solvent removing means 14, the liquid coating means 16, and the control means 18 in the image forming apparatus 10 in FIG. 1. Therefore, they are denoted by the same reference numerals as those in FIG. 1, and the detailed description of the same components as those in FIG. 1 will be omitted here. Furthermore, the recording means 66 and the fixing means 70 in the image forming apparatus 60 in FIG. 6 respectively correspond to the forming means 12 and the fixing means 20 in the image forming apparatus 10 in FIG. 1.

First, the holding means 62 for the recording medium P will be described.

The holding means 62 includes a sheet feed tray 74 for holding the recording medium P before recording, a pickup roller 76, and a sheet discharge tray 78 for holding the recording medium P after completion of the recording.

The sheet feed tray 74 holds sheets of recording medium P supplied for recording, and is inserted in the housing 61 from a left side of the housing 61 in FIG. 6. The pickup roller 76 is placed in the vicinity of a forward end portion (right end portion in FIG. 6) of a mounting portion into which the sheet feed tray 74 is inserted. During recording of an image, the sheets of the recording medium P are taken out one by one from the sheet feed tray 74 by the pickup roller 76 to be supplied to the transporting means 64 for the recording medium P. In the vicinity of the pickup roller 76, in order to facilitate the separation of the recording medium P whose sheets are stacked on one another, a discharging brush or a discharging roller for discharging the recording medium P, an air blower and the like are preferably provided.

The sheet discharge tray 78 holds the recording medium P on which an image is formed. The sheet discharge tray 78 is provided at the forward end of the transport path of the recording medium P in the housing 61, and the forward end portion of the tray 78 (forward end side in the transport direction of the recording medium P) is placed outside the housing 61. The recording medium P after completion of the recording is transported by the transporting means 64 to be discharged to the sheet discharge tray 78.

Next, the transporting means 64 for the recording medium P will be described.

The transporting means 64 transports the recording medium P along a predetermined path from the sheet feed tray 74 to the sheet discharge tray 78, and includes a transporting roller pair 80, a transporting belt 82, belt rollers 84a, 84b, a conductive platen 86, a charger 88 and a discharger 90 of the recording medium P, a separation claw 92, and a sheet discharging roller 96. As the transporting means 64, in addition to the components shown in FIG. 6, ordinary transporting members such as a transporting roller pair, a transporting belt, and a transporting guide may be arranged as required at appropriate intervals for transporting the recording medium P.

The transporting roller pair 80 is provided at a position between the pickup roller 76 and the transporting belt 82. The recording medium P taken out of the sheet feed tray 74 by the pickup roller 76 is transported by the transporting roller pair 80 and the transporting belt 82 while being nipped therebetween, and supplied to a predetermined position on the transporting belt 82.

The transporting belt 82 is a loop-shaped endless belt, and stretched around two belt rollers 84a, 84b. At least one of the belt rollers 84a, 84b is connected to a driving source (not shown), and during recording, rotated at a predetermined speed. Because of this, the transporting belt 82 travels around the belt rollers 84a, 84b clockwise in FIG. 6, and transports the recording medium P electrostatically attracted to the transporting belt 82 at a predetermined speed.

The surface (front surface) of the transporting belt 82 to which the recording medium P is electrostatically attracted, has an insulating property, and the surface (reverse surface) thereof which is in contact with the belt rollers 84a, 84b has conductivity. Furthermore, on an inner surface side of the transporting belt 82, a conductive platen 86 is placed over a region extending from a position opposed to the charger 88 and a position opposed to the ink jet head 108, and the belt rollers 84a, 84b and the conductive platen 86 are grounded. Because of this, the transporting belt 82 also functions as a counter electrode of the ink jet head 108 at a position opposed to the ink jet head 108.

It is preferable that the conductive platen 86 be placed so as to slightly protrude toward the ink jet head 108 side from a line connecting the circumferences of the belt rollers 84a and 84b. By placing the conductive platen 86 as described above, tension is applied to the transporting belt 82 to suppress flapping.

The charger 88 for the recording medium P includes a scorotron charger 98 and a negative high-voltage source 100. The scorotron charger 98 is placed so as to be opposed to the surface of the transporting belt 82 at a position between the transporting roller pair 80 and the recording means 66 on a transport path of the recording medium P. Furthermore, the scorotron charger 98 is connected to a terminal on a negative side of the negative high-voltage source 100, and a terminal on a positive side of the negative high-voltage source 100 is grounded.

The surface of the recording medium P is uniformly charged to a predetermined negative high potential by the scorotron charger 98 connected to the negative high-voltage source 100, and a constant DC bias voltage (e.g., about −1.5 kV) required for recording is applied to the surface. Consequently, the recording medium P is electrostatically attracted to the surface of the transporting belt 82 having an insulating property.

The discharger 90 of the recording medium P includes a corotron discharger 102, an AC voltage source 104, and a high-voltage source 106. The corotron discharger 102 is placed so as to be opposed to the surface of the transporting belt 82 on a downstream side of the recording means 66 in the transport direction of the recording medium P. The corotron discharger 102 is connected to the high-voltage source 106 via the AC voltage source 104, and the other terminal of the high-voltage source 106 is grounded.

The recording medium P after the recording is discharged by the corotron discharger 102, and thereafter, is separated from the transporting belt 82 by the separation claw 92 placed on a downstream side of the corotron discharger 102. The recording medium P separated from the transporting belt 82 is transported to the fixing means 70, subjected to a fixing process by the fixing means 70, and is discharged to the sheet discharge tray 78 by the sheet discharging roller 96.

Next, the recording means 66 will be described.

The recording means 66 uses ink containing charged color particles, and controls the ejection of ink with an electrostatic force in accordance with image data, thereby recording an image on the recording medium P in accordance with the image data. The recording means 66 includes the electrostatic ink jet head 108, a head driver 110, an ink circulation mechanism 112, and a position detector 114 of the recording medium P.

The ink jet head 108 is placed at a position through which the recording medium P is transported by the transporting belt 82 in a stable flat state in the transport path of the recording medium P in such a manner that its ink ejection portion is positioned at a predetermined distance from the surface of the transporting belt 82 (surface of the recording medium P held on the surface of the transporting belt 82). In the illustrated example, the ink jet head 108 is placed between the belt rollers 84a and 84b so as to be opposed to the transporting belt 82.

The ink jet head 108 is a line head capable of recording an image of one row simultaneously, and is provided with ejection heads of four colors of cyan (C), magenta (M), yellow (Y), and black (B) for recording a full-color image. The ejection head of each color basically has the same configuration, so that an ejection head 160 of one color will be described below.

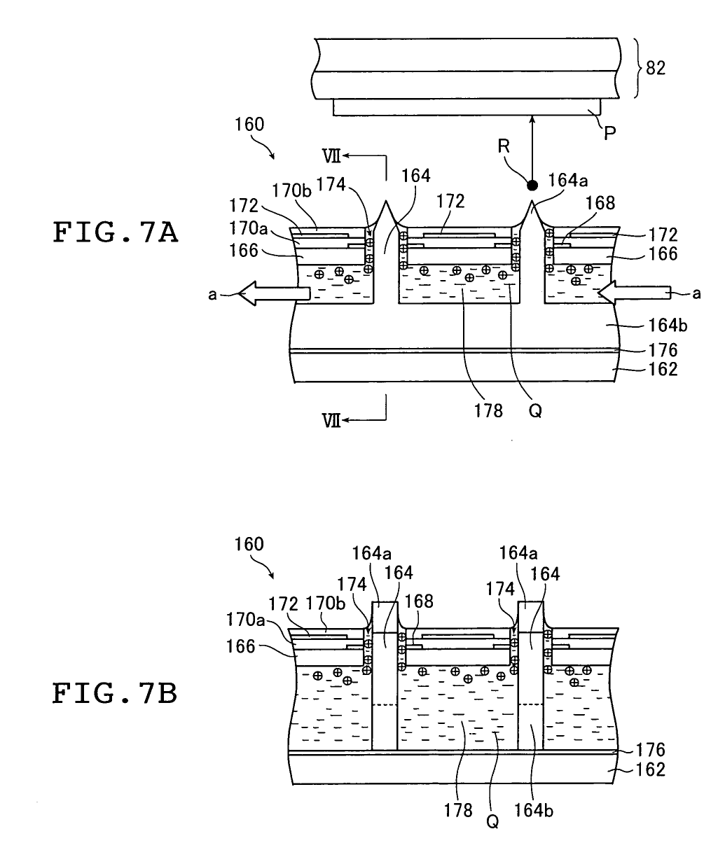

FIG. 7 is a schematic view illustrating a specific configuration of the ejection head 160 in the electrostatic ink jet head 108. FIG. 7A is a schematic cross-sectional view showing a part of the ejection head 160, and FIG. 7B is a schematic cross-sectional view taken along the line VII-VII of FIG. 7A. The ejection head 160 is a multi-channel head provided with nozzles two-dimensionally. Herein, in order to clarify the configuration, only two ejection portions are shown.

The ejection head 160 includes a head substrate 162, ink guides 164 (ink guide projections 164), a nozzle substrate 166, ejection electrodes 168, and a floating conductive plate 176. The ejection head 160 is placed so that the tip end of the ink guide 164 as the ejection (flying) point of an ink droplet R is opposed to the transporting belt 82 which supports the recording medium P and servers as a counter electrode.

The head substrate 162 and the nozzle substrate 166 are flat substrates common to all the nozzles of the ejection head 160, and are made of an insulating material. The head substrate 162 and the nozzle substrate 166 are placed at a predetermined distance from each other, and an ink flow path 178 is formed therebetween. The ink Q in the ink flow path 178 contains color particles charged to the voltage identical in polarity to that applied to the ejection electrode 168, and during recording, the ink Q is circulated in the ink flow path 178 at a predetermined speed (e.g., ink flow rate of 200 mm/s) in a predetermined direction, and in the example shown in FIG. 7A, from the right side to the left side (direction indicated by an arrow a in FIG. 7A). Hereinafter, the case where the color particles in ink are positively charged will be described.

In the nozzle substrate 166, nozzles 174 (orifices 174) serving as ejection ports for the ink Q are formed, and the nozzles 174 are placed two-dimensionally at predetermined intervals. Furthermore, an ink guide 164 for determining the ejection (flying) point of the ink Q is placed in the center of the nozzle 174.

The ink guide 164 is a plate made of an insulating resin with a predetermined thickness, has a protruding tip end portion 164a, and is placed on the head substrate 162 at a position corresponding to each nozzle 174. The ink guide 164 has a base 164b common to the ink guides 164 arranged in the same column (in a horizontal direction in FIG. 7A, and in a direction vertical to the paper surface of FIG. 7B), and the base 164b is fixed on the head substrate 162 with the floating conductive plate 176 interposed therebetween.

Furthermore, the tip end portion 164a of the ink guide 164 is placed so as to protrude from the outermost surface of the ejection head 160 on the recording medium P (transporting belt 82) side. The shape and structure of the tip end portion 164a are set so that the ejection portion of the ink Q (ink droplet R) can be stabilized and the ink Q can be sufficiently supplied to the tip end portion 164a, where the color particles in the ink Q are concentrated into a preferable state. For example, the tip end portion 164a gradually tapered toward the ejecting direction, the tip end portion 164a in which a slit serving as an ink guide groove is formed in a vertical direction in FIG. 7A, the tip end portion 164a to which a metal is vapor-deposited to substantially increase the dielectric constant of the tip end portion 164a, and the like are preferable.

On the surface (upper surface in FIG. 7A) of the nozzle substrate 166 on the recording medium P side, ejection electrodes 168 are placed so as to surround the respective nozzles 174. Furthermore, on the recording medium P side of the nozzle substrate 166, an insulating layer 170a covering upper portions (upper surfaces) of the ejection electrodes 168, a sheet-shaped guard electrode 172 placed above the ejection electrodes 168 via the insulating layer 170a, and an insulating layer 170b covering the upper surface of the guard electrode 172 are provided.

The ejection electrodes 168 are placed in a ring shape for each ejection portion (i.e., as circular electrodes) on the upper side of the nozzle substrate 166 in FIG. 7A (i.e., on the surface of the nozzle substrate 166 on the recording medium P side) so as to surround the nozzles 174 formed in the nozzle substrate 166. The ejection electrode 168 is not limited to a circular electrode, and it may be a substantially circular electrode, a divided circular electrode, a parallel electrode, or a substantially parallel electrode.

The ejection electrodes 168 are controlled by the head driver 110, and supplied with a predetermined pulse voltage in accordance with image data. As described above, at a position opposed to the ink guide 164, the recording medium P charged to a voltage opposite in polarity to that of the charged color particles in ink is transported at a predetermined speed while being held by the transporting belt 82. The recording medium P is charged to a negative high voltage (e.g., −1500 V), and a predetermined electric field which does not cause ejection of the ink Q is formed between the recording medium P and the ejection electrodes 168.

When the ejection electrodes 168 are in an ejection OFF state (ejection stand-by state), a pulse voltage applied is OV or low. In this state, the electric field intensity in the ejection portion is set by a bias voltage (or a bias voltage superposed on a pulse voltage in the OFF state), which is set lower than the intensity required for ejecting the ink Q, so that the ink Q is not ejected. However, owing to the low electric field in the ejection stand-by state, the color particles in ink inside the nozzle 174 are concentrated at the tip end portion 164a of the ink guide 164.

When the ejection electrode 168 is in an ejection ON state, a pulse voltage is applied, and a high pulse voltage (e.g., 400 to 600 V) is superposed on the bias voltage, the electric field intensity of the ejection portion has an intensity sufficient for the ink Q to be ejected, and the ink Q concentrated at the tip end portion 164a of the ink guide 164 flies as the ink droplet R. Since the size of the ink droplet R is very small, a high-quality and high-resolution image can be recorded.

Thus, ON/OFF control is performed on the ejection electrode 168 of each ejection portion arranged over the entire width of the recording medium P in accordance with image data, and ink is ejected at a predetermined timing on the recording medium P transported at a predetermined speed, whereby a two-dimensional image is recorded on the recording medium P.

The guard electrode 172 is placed between the ejection electrodes 168 of adjacent ejection portions, and suppresses the interference of an electric field occurring between the ink guides 164 of adjacent ejection portions. The guard electrode 172 is a sheet-shaped electrode such as a metal plate common to all the ejection portions of the ejection head 160, and portions corresponding to the ejection electrodes 168 formed on the periphery of the respective nozzles 174 arranged two-dimensionally are perforated. By providing the guard electrode 172, even in the case where the nozzles 174 are arranged at a high density, the influence of an electric field of the adjacent nozzles 174 can be minimized, and the dot size and the drawing position of a dot can be kept consistently.

On the surface of the head substrate 162 on the ink flow path 178 side, the floating conductive plate 176 is placed. The floating conductive plate 176 is electrically insulated (in a high impedance state). The floating conductive plate 176 generates an induced voltage in accordance with the value of the voltage applied to the ejection portion during image recording, and allows the color particles to migrate to the nozzle substrate 166 side in the ink Q flowing in the ink flow path 78. Furthermore, on the surface of the floating conductive plate 176, an electrically insulating coating film (not shown) is formed, whereby the physical properties and components of ink are prevented from becoming unstable due to charge injection into the ink and the like. As the insulating coating film, the one having resistance to corrosion caused by ink can be used.

By providing the floating conductive plate 176, the color particles in the ink Q flowing in the ink flow path 178 are allowed to migrate to the nozzle substrate 166 to increase the concentration of the color particles in the ink Q flowing through the nozzles 174 of the nozzle substrate 166 to a predetermined level and to concentrate the ink Q at the tip end portion 164a of the ink guide 164, whereby the concentration of the color particles in the ink Q to be ejected in the form of the ink droplet R can be stabilized at the predetermined level.

In the illustrated example, the ejection electrodes have a single layer electrode structure. However, the ejection electrodes may have, for example, a two-layer electrode structure which includes first ejection electrodes connected in a column direction and second ejection electrodes connected in a row direction, and in which the first ejection electrodes and the second ejection electrodes are arranged in a matrix to perform matrix driving. According to such a matrix driving system, the higher integration of the ejection electrodes and the simplification of the driver wiring can be realized simultaneously.

The ink circulation mechanism 112 includes an ink tank 116, a pump (not shown), an ink supply path 118a, and an ink recovery path 118b. The ink tank 116 is placed on the inner bottom surface of the housing 61, and is connected to the ink jet head 108 via the ink supply path 118a and the ink recovery path 118b.

The ink tank 116 contains ink of four colors, each of which contains color particles of each color and a dispersion solvent for dispersing the color particles. The ink of each color in the ink tank 116 is supplied by the pump to the ejection head of each color in the ink jet head 108 via the ink supply path 118a. Furthermore, excessive ink of each color that has not been used for recording an image is recovered to the ink tank 116 for each color via the ink recovery path 118b. The ink tank 116 also contains a dispersion solvent containing no color particles. The dispersion solvent is used for supplying ink of each color and adjusting the concentration of ink, and is also supplied to the liquid coating means 16.

Next, the ink Q (ink composition) used in the ink jet head 108 will be described. In the electrostatic ink jet head 108, the ink Q containing color particles (charged fine particles containing colorants) dispersed in a solvent (ink solvent, carrier liquid) is used.

It is preferable that the carrier liquid (ink solvent) be a dielectric liquid (non-aqueous solvent) having a high electric resistivity (10⁹ Ω·cm or more, preferably 10¹⁰ Ω·cm or more). When the carrier liquid having a high electric resistivity is used, the voltage applied by the ejection electrode can reduce the charge injection received by the carrier liquid, the concentration of the charged particles (charged fine particle component) can be increased, and the charged particles can be concentrated. Furthermore, the carrier liquid having a high electric resistivity can also contribute to the prevention of electric conduction between adjacent ejection electrodes. Furthermore, when ink made of liquid having an electric resistivity within the above-mentioned range is used, ink can be ejected satisfactorily even under a low electric field.

The relative permittivity of the dielectric liquid used as the carrier liquid is preferably equal to or smaller than 5, more preferably equal to or smaller than 4, and much more preferably equal to or smaller than 3.5. Such a range is selected for the relative permittivity, whereby the electric field effectively acts on the color particles contained in the carrier liquid to facilitate the electrophoresis of the color particles.

Note that the upper limit of the specific electrical resistance of the carrier liquid is desirably about 10¹⁶ Ω·cm, and the lower limit of the relative permittivity is desirably about 1.9. The reason why the electrical resistance of the carrier liquid preferably falls within the above-mentioned range is that if the electrical resistance becomes low, then the ejection of the ink droplets under a low electric field becomes worse. Also, the reason why the relative permittivity preferably falls within the above-mentioned range is that if the relative permittivity becomes high, then the electric field is relaxed due to the polarization of the solvent, and as a result the color of dots formed under this condition becomes light, or the bleeding occurs.

Preferred examples of the dielectric liquid used as the carrier liquid include straight-chain or branched aliphatic hydrocarbons, alicyclic hydrocarbons, aromatic hydrocarbons, and the same hydrocarbons substituted with halogens. Specific examples thereof include hexane, heptane, octane, isooctane, decane, isodecane, decalin, nonane, dodecane, isododecane, cyclohexane, cyclooctane, cyclodecane, benzene, toluene, xylene, mesitylene, Isopar C, Isopar E, Isopar G, Isopar H, Isopar L, Isopar M (Isopar: a trade name of EXXON Corporation), Shellsol 70, Shellsol 71 (Shellsol: a trade name of Shell Oil Company), AMSCO OMS, AMSCO 460 Solvent, (AMSCO: a trade name of Spirits Co., Ltd.), a silicone oil (such as KF-96L, available from Shin-Etsu Chemical Co., Ltd.). The dielectric liquid may be used singly or as a mixture of two or more thereof.

For such color particles dispersed in the carrier liquid (ink solvent), colorants themselves may be dispersed as the color particles into the carrier liquid, but dispersion resin particles are preferably contained for enhancement of fixing property. In the case where the dispersion resin particles are contained in the carrier liquid, in general, there is adopted a method in which pigments are covered with the resin material of the dispersion resin particles to obtain particles covered with the resin, or the dispersion resin particles are colored with dyes to obtain the colored particles.

As the colorants, pigments and dyes conventionally used in ink compositions for ink jet recording, (oily) ink compositions for printing, or liquid developers for electrostatic photography may be used.

Pigments used as colorants may be inorganic pigments or organic pigments commonly employed in the field of printing technology. Specific examples thereof include but are not particularly limited to known pigments such as carbon black, cadmium red, molybdenum red, chrome yellow, cadmium yellow, titanium yellow, chromium oxide, viridian, cobalt green, ultramarine blue, Prussian blue, cobalt blue, azo pigments, phthalocyanine pigments, quinacridone pigments, isoindolinone pigments, dioxazine pigments, threne pigments, perylene pigments, perinone pigments, thioindigo pigments, quinophthalone pigments, and metal complex pigments.

Preferred examples of dyes used as colorants include oil-soluble dyes such as azo dyes, metal complex salt dyes, naphthol dyes, anthraquinone dyes, indigo dyes, carbonium dyes, quinoneimine dyes, xanthene dyes, aniline dyes, quinoline dyes, nitro dyes, nitroso dyes, benzoquinone dyes, naphthoquinone dyes, phthalocyanine dyes, and metal phthalocyanine dyes.

Further, examples of dispersion resin particles include rosins, rosin-modified phenol resin, alkyd resin, a (meta)acryl polymer, polyurethane, polyester, polyamide, polyethylene, polybutadiene, polystyrene, polyvinyl acetate, acetal-modified polyvinyl alcohol, and polycarbonate.

Of those, from the viewpoint of ease for particle formation, a polymer having a weight average molecular weight in a range of 2,000 to 1,000,000 and a polydispersity (weight average molecular weight/number average molecular weight) in a range of 1.0 to 5.0 is preferred. Moreover, from the viewpoint of ease for the fixation, a polymer in which one of a softening point, a glass transition point, and a melting point is in a range of 40° C. to 120° C. is preferred.

In ink Q, the content of color particles (total content of color particles and dispersion resin particles) preferably falls within a range of 0.5 to 30.0 wt % for the overall ink, more preferably falls within a range of 1.5 to 25.0 wt %, and much more preferably falls within a range of 3.0 to 20.0 wt %. If the content of color particles decreases, the following problems become easy to arise. The density of the printed image is insufficient, the affinity between the ink Q and the surface of a recording medium P becomes difficult to obtain to prevent the image firmly stuck to the surface of the recording medium P from being obtained, and so forth. On the other hand, if the content of color particles increases, problems occur in that the uniform dispersion liquid becomes difficult to obtain, the clogging of the ink Q is easy to occur in the ink jet head 108 or the like to make it difficult to obtain the stable ink ejection, and so forth.

In addition, the average particle diameter of the color particles dispersed in the carrier liquid preferably falls within a range of 0.1 to 2.0 μm, more preferably falls within a range of 0.2 to 1.5 μm, and much more preferably falls within a range of 0.4 to 1.0 μm. Those particle diameters are measured with CAPA-500 (a trade name of a measuring apparatus manufactured by HORIBA LTD.).

After the color particles are dispersed in the carrier liquid and optionally a dispersing agent, a charging control agent is added to the resultant carrier liquid to charge the color particles, and the charged color particles are dispersed in the resultant liquid to thereby produce the ink Q. Note that in dispersing the color particles in the carrier liquid, a dispersion medium may be added if necessary.

As the charging control agent, for example, various ones used in the electrophotographic liquid developer can be utilized. In addition, it is also possible to utilize various charging control agents described in “DEVELOPMENT AND PRACTICAL APPLICATION OF RECENT ELECTRONIC PHOTOGRAPH DEVELOPING SYSTEM AND TONER MATERIALS”, pp. 139 to 148; “ELECTROPHOTOGRAPHY-BASES AND APPLICATIONS”, edited by THE IMAGING SOClETY OF JAPAN, and published by CORONA PUBLISHING CO. LTD., pp. 497 to 505, 1988; and “ELECTRONIC PHOTOGRAPHY” by Yuji Harasaki, 16(No. 2), p. 44, 1977.

The color particles are charged particles identical in polarity to the drive voltages applied to the ejection electrodes. The charging amount of the color particles is preferably in a range of 5 to 200 μC/g, more preferably in a range of 10 to 150 μC/g, and much more preferably in a range of 15 to 100 μC/g.

In addition, the electrical resistance of the dielectric liquid may be changed by adding the charging control agent in some cases. Thus, the distribution factor P defined below is preferably equal to or larger than 50%, more preferably equal to or larger than 60%, and much more preferably equal to or larger than 70%.
P=100×(σ1−σ2)/σ1
where σ1 is an electric conductivity of the ink Q, and σ2 is an electric conductivity of a supernatant liquid which is obtained by inspecting the ink Q with a centrifugal separator. Those electric conductivities were obtained by measuring the electric conductivities of the ink Q and the supernatant liquid under a condition of an applied voltage of 5 V and a frequency of 1 kHz using an LCR meter of an AG-4311 type (manufactured by ANDO ELECTRIC CO., LTD.) and electrode for liquid of an LP-05 type (manufactured by KAWAGUCHI ELECTRIC WORKS, CO., LTD.). In addition, the centrifugation was carried out for 30 minutes under a condition of a rotational speed of 14,500 rpm and a temperature of 23° C. using a miniature high speed cooling centrifugal machine of an SRX-201 type (manufactured by TOMY SEIKO CO., LTD.).

The ink Q as described above is used, which results in that the color particles are likely to migrate and hence the color particles are easily concentrated.

The electric conductivity of the ink Q is preferably in a range of 100 to 3,000 pS/cm, more preferably in a range of 150 to 2,500 pS/cm, and much more preferably in a range of 200 to 2,000 pS/cm. The range of the electric conductivity as described above is set, resulting in that the applied voltages to the ejection electrodes are not excessively high, and also there is no anxiety to cause the electrical conduction between the adjacent ejection electrodes.

In addition, the surface tension of the ink Q is preferably in a range of 15 to 50 mN/m, more preferably in a range of 15.5 to 45.0 mN/m, and much more preferably in a range of 16 to 40 mN/m. The surface tension is set in this range, resulting in that the applied voltages to the ejection electrodes are not excessively high, and also the ink does not leak or spread to the periphery of the head to contaminate the head.

Moreover, the viscosity of the ink Q is preferably in a range of 0.5 to 5.0 mPa·sec, more preferably in a range of 0.6 to 3.0 mPa·sec, and much more preferably in a range of 0.7 to 2.0 mPa·sec.

The ink Q can be prepared for example by dispersing color particles into a carrier liquid to form particles and adding a charging control agent to the dispersion medium (dispersion solvent) to allow the color particles to be charged. The following methods are given as the specific methods.
(1) A method including: previously mixing (kneading) a colorant and/or dispersion resin particles; dispersing the resultant mixture into a carrier liquid using a dispersing agent when necessary; and adding the charging control agent thereto.
(2) A method including: adding a colorant and/or dispersion resin particles and a dispersing agent into a carrier liquid at the same time for dispersion; and adding the charging control agent thereto.
(3) A method including adding a colorant and the charging control agent and/or the dispersion resin particles and the dispersing agent into a carrier liquid at the same time for dispersion.

The position detector 114 for the recording medium P is conventionally known position detecting means such as a photosensor, and is placed so as to be opposed to the surface of the transporting belt 82 by which the recording medium P is transported, at a predetermined position (position between the transporting roller pair 80 and the charger 88 in the illustrated example) on an upstream side of the ink jet head 108 on a transport path of the recording medium P. The positional information on the recording medium P as detected by the position detector 114 is supplied to the head driver 110.

The head driver 110 is a driver of the ink jet head 108, and is connected to the ink jet head 108 via a driving signal cable. In the illustrated example, the head driver 110 is attached to a central upper portion in the housing 61 (see FIG. 6). Image data is input to the head driver 110 from an external apparatus, and the positional information on the recording medium P is input thereto from the position detector 114. While the ejection timing of the ejection head of each color in the ink jet head 108 is controlled in accordance with the positional information on the recording medium P, the ink of each color is ejected from the ejection head for each color in accordance with image data, whereby a full color image corresponding to the image data is recorded on the recording medium P.

Next, the solvent removing means 14, the liquid coating means 16, and the control means 18 for controlling the glossiness of a recorded image under the control of the solvent removing means 14 and the liquid coating means 16, which are characteristic components of the present invention, will be described.

The solvent removing means 14, the liquid coating means 16, and the control means 18 have the same configurations as those in the image forming apparatus 10 shown in FIG. 1. More specifically, the solvent removing means 14 removes an ink solvent of an ink image recorded (formed) on the recording medium P by the recording means 66. The liquid coating means 16 coats an ink image with the liquid L. Then, the removal of the ink solvent by the solvent removing means 14 and the coating of the liquid L by the liquid coating means 16 are controlled by the control means 18. Furthermore, the amount of the ink solvent removed by the solvent removing means 14 and the amount of the liquid L applied by the liquid coating means 16 are adjusted by the control means 18.

In the image forming apparatus 60, the liquid L applied by the liquid coating means 16 is the same as the ink solvent constituting the ink Q supplied to the ink jet head 108. The nozzle 26 and the pump 28 of the liquid coating means 16 are connected to the tank of the ink solvent (dispersion solvent) provided in the ink tank 116.

The control means 18 is connected to designation input means (not shown), and controls the solvent removing means 14 and the liquid coating means 16 in accordance with a designation input by an operator etc. for designating at least one of the glossiness of a fixed image and the kind of the recording medium P.

Next, the fixing means 70 will be described.

The fixing means 70 fixes an image recorded on the recording medium P by the recording means 66 by heating, and includes a heating roller 130 and a pressing roller 132. The heating roller 130 and the pressing roller 132 sandwich and transport the recording medium P, thereby fixing an ink image recorded (formed) on the recording medium P, and have the same configurations as those of the heating roller 30 and the pressing roller 32 in the above-mentioned image forming apparatus 10 (see FIG. 1). Therefore, the description of the configurations thereof will be omitted here.

The heating roller 130 and the pressing roller 132 may be heating rollers, and the surface temperature of the heating roller 130 and the pressing force (nip force) applied to the recording medium P by the pressing roller 132 may be appropriately set so as to ensure a desired fixing property, which is as in the above embodiment.

Next, the solvent colleting means 72 will be described.

The solvent collecting means 72 collects a dispersion solvent evaporated from ink ejected from the ink jet head 108 to the recording medium P, a dispersion solvent evaporated from ink during fixing of an image, and the like, and includes an activated carbon filter 134 and an exhaust fan 136. The activated carbon filter 134 is attached to an inner surface of the housing 61 on the right side in FIG. 6, and the exhaust fan 136 is attached onto the activated carbon filter 134.

The air containing dispersion solvent components inside the housing 61 generated by the natural evaporation of the ink solvent from the ink ejected from the ink jet head 108, the natural evaporation of the ink solvent forming an unfixed image on the recording medium P, and the evaporation of the ink solvent generated during fixing by the fixing means 70 are collected by the exhaust fan 136 and passes through the activated carbon filter 134, whereby the solvent components are removed by being attracted to the activated carbon filter 134, and the air with the dispersion solvent components removed therefrom is exhausted to the outside of the housing 61.

Hereinafter, the function of the ink jet recording apparatus 60 will be described.

Prior to the recording operation, first, an operator designates desired glossiness of an image to be recorded on the recording medium P through the designation input means (not shown). The designation input through the designation input means is transmitted to the control means 18, and the solvent removing means 14 and the liquid coating means 16 are controlled by the control means 18 in accordance with an input designation.

For example, in the case where a designation for recording an image with high glossiness on the recording medium P is input, the liquid coating means 16 is set so as to operate under the control by the control means 18, and the amount of the liquid L applied by the liquid coating means 16 is adjusted. On the other hand, in the case where a designation for recording an image with suppressed glossiness on the recording medium P is input, the solvent removing means 14 is set so as to operate under the control by the control means 18, and the amount of the ink solvent removed by the solvent removing means 14 is adjusted. Furthermore, if the designated glossiness is obtained under a normal condition, the solvent removing means 14 and the liquid coating means 16 do not operate.

Furthermore, the kind of the recording medium P may also be input by the designation input means. In this case, the control means 18 sets the operation in the solvent removing means 14 or the liquid coating means 16 so that desired glossiness such as glossiness designated through designation input, predetermined glossiness is expressed on the recorded image in the target recording medium P, and the amount of the ink solvent removed by the solvent removing means 14 and the amount of the liquid L applied by the liquid coating means 16 are set.

Such a designation to be input for glossiness may be set for each image formed by the image forming apparatus 60, and control may be performed so that each of the solvent removing means 14 and the liquid coating means 16 operate in synchronization with the transport of the recording medium P on which an ink image corresponding to the input designation is formed.

At the time of starting the recording operation, sheets of the recording medium P in the sheet feed tray 74 is taken out one by one by the pickup roller 76, and supplied to a predetermined position on the transporting belt 82 while being held and transported by the transporting roller pair 80. The recording medium P supplied onto the transporting belt 82 is charged to a negative high potential by the charger 88, and electrostatically attracted to the surface of the transporting belt 82.

While the recording medium P electrostatically attracted to the surface of the transporting belt 82 is moved at a predetermined constant speed along with the movement of the transporting belt 82, an image corresponding to image data is recorded on the surface of the recording medium P by the ink jet head 108.

The recording medium P after the completion of the image recording is transported to the positions of the solvent removing means 14 and the liquid coating means 16 by the transporting belt 82, and the removal of the ink solvent by the solvent removing means 14 or the coating of the liquid L by the liquid coating means 16 is performed under a condition set under the control by the control means 18. Thereafter, the recording medium P is further transported by the transporting belt 82, discharged by the discharger 90, separated from the transporting belt 82 by the separation claw 92, and supplied to the fixing means 70.

In the fixing means 70, the recording medium P is held and transported by the heating roller 71 and the pressing roller 74, and application of heat and pressure to the recording medium P allows an image to be fixed thereon. The recording medium P on which the image has been fixed is then discharged from the image forming apparatus 60 and put in the sheet discharge tray 78. The thus obtained image on the recording medium P expresses desired glossiness conforming to the designation input through the designation input means (not shown).

The ink jet image forming apparatus and method according to the present invention have been described in detail. However, the present invention is not limited to the above-mentioned various embodiments, and may be variously changed and modified without departing from the spirit of the present invention.

1. An ink jet image forming apparatus, comprising:
forming means for forming an image on a recording medium, using ink containing particles including at least a colorant and a solvent;
fixing means for performing heat-fixing of the image formed by the forming means to thereby obtain a fixed image;
solvent removing means for removing the solvent in the ink forming the image before the heat-fixing by the fixing means; and
liquid coating means for coating the recording medium with a fixing assistant liquid for accelerating the heat-fixing of the image formed with the ink.

2. The ink jet image forming apparatus according to claim 1, further comprising control means for controlling glossiness of the fixed image by controlling whether or not the solvent in the ink forming the image is removed by the solvent removing means and whether or not the fixing assistant liquid is applied by the liquid coating means.

3. The ink jet image forming apparatus according to claim 2, wherein the control means controls the glossiness of the fixed image by controlling whether or not the solvent in the ink forming the image is removed by the solvent removing means and whether or not the fixing assistant liquid is applied by the liquid coating means, in accordance with one or both of the glossiness to be expressed by the fixed image and a kind of the recording medium.

4. The ink jet image forming apparatus according to claim 2, wherein, when performing one or both of removal of the solvent by the solvent removing means and application of the fixing assistant liquid by the liquid coating means, the control means adjusts one or both of an amount of the solvent removed from the ink forming the image by the solvent removing means and an amount of the fixing assistant liquid applied by the liquid coating means, in accordance with one or both of the glossiness to be expressed by the fixed image and a kind of the recording medium.

5. The ink jet image forming apparatus according to claim 1, wherein the fixing means fixes the image by bringing a heating member into contact with the recording medium.

6. An ink jet image forming method, comprising:
forming an image on a recording medium using ink containing particles including at least a colorant and a solvent;
determining whether or not the solvent in the ink forming the image is removed and whether or not the recording medium is coated with a fixing assistant liquid for accelerating heat-fixing of the image formed with the ink so that glossiness of a fixed image is controlled; and
heat-fixing the image based on a determination made on removal and application to obtain the fixed image.

7. The ink jet image forming method according to claim 6, wherein whether or not the solvent in the ink forming the image is removed and whether or not the recording medium is coated with the fixing assistant liquid for accelerating the heat-fixing of the image formed with the ink are determined in accordance with one or both of the glossiness to be expressed by the fixed image and a kind of the recording medium.

8. The ink jet image forming method according to claim 6, wherein, when performing one or both of removal of the solvent in the ink forming the image and application of the fixing assistant liquid to the recording medium, one or both of an amount of the solvent removed from the ink forming the image and an amount of the fixing assistant liquid applied are adjusted, in accordance with one or both of the glossiness to be expressed by the fixed image and a kind of the recording medium.
